(19) United States
(12) Patent Application Publication
(10) Pub. No.: US 2005/0253694 A1
(43) Pub. Date: Nov. 17, 2005

(54) Vehicle mounted pedestrian sensor system

(76) Inventor: Mark E. Kuznarowis, Fountain Hills, AZ (US)

Correspondence Address: THE INVENTORS NETWORK, INC., 332 ACADEMY STREET, CARNEGIE, PA, 15106, US

(21) Appl. No.: 10/846,421

(22) Filed: May 17, 2004

(51) Int. Cl. B60Q 1/00

(52) U.S. Cl. 340/436; 340/433

(57) ABSTRACT

A vehicle mounted sensor system for detecting the presence of objects and individuals adjacent a vehicle such as a commuter bus includes at least four motion detectors mounted to the front, back and both sides of the vehicle, an electrical control box for receiving and interpreting signals generated by the motion detectors, and a display and control panel having indicator lamps that light in response to one or more of motion detectors being triggered by the presence of an individual within the preset detection range. The control panel also includes a tone or alarm that will also sound in response to the detection of the presence of an individual. An integral sensing switch is interconnected to the control box and either the transmission, the drive shaft or a wheel hub for detecting when the vehicle comes to a stop so that the sensor system can be immediately activated; and when the vehicle resumes motion, the sensor system goes to a standby mode until the integral sensing switch detects the next stoppage of the vehicle and the system is activated.

### FIELD OF THE INVENTION

The present invention pertains to motion sensing and detection devices, and more particularly pertains to a motion sensing system that immediately alerts the operator of a motorized vehicle of the presence of pedestrians within a predetermined area about the motorized vehicle.

### BACKGROUND OF THE INVENTION

Systems and devices to sense and detect the motion, movement or presence of objects and individuals are widespread throughout society. The primary purpose of such sensing and detecting devices is for providing safety to the users and monitors of the devices and systems in so far as they alerted or warned of presence of interlopers or intruders. Two of the most common sensing and detecting devices and systems are the integrated light and motion detectors utilized on residential, commercial and industrial dwellings and sites, and the photoelectric eye found in doorways and entranceways or all manner of buildings and structures. In both cases it is the interruption of a generated physical phenomena—an electromagnetic beam, for example—that initiates a series of actions such as the closing of a circuit to open a door or turn on an overhead light.

The above examples pertain to stationary motion and detection systems and devices. In our vehicle dominated world safety and alarm systems and devices on vehicles are being utilized to warn drivers and operators of the presence of pedestrians, passengers, and, especially, children. Such systems and devices are legally mandated on public transportation buses, garbage trucks, and construction equipment; but they primarily consist of an alarm buzzer engaged by the operator as a warning for individuals to stand clear. A critical limitation is that the alarm buzzer is activated only when the vehicle is backing up, but not when the vehicle is moving forward. However, given the size of buses, garbage trucks, and construction equipment, and the fact that the forward and sideways visibility is often limited or obstructed due to the location of the drivers seat or cab, the operator may not see pedestrians or individuals standing or moving in front of the vehicle even when the vehicle is moving directly forward. Thus, a crude safety device used by school buses is a swing arm mounted at the front of the bus and which swings out while children are embarking and disembarking; but the safety arm is more to alert vehicles adjacent to the bus that loading and unloading is occurring and that they should come to a stop. Nonetheless, safety arm doesn't sense anyone's movement or motion about the bus and is under the direct manual control of the bus driver.

In view of the above the prior art discloses a number of systems and devices for detecting motion by individuals and objects.

For example, the Philipp patent (U.S. Pat. No. 4,736,097) discloses an optical motion sensor that includes a pair of diodes that convey sensing signals to an amplifier and a sampling circuit for converting a time varying signal to a detection signal.

The Rosenfield et al. patent (U.S. Pat. No. 4,914,422) discloses a temperature and motion sensor that can be worn by safety personnel such as firemen, and which includes a housing mounted to the individual for sensing temperature changes in 100 degree increments and an activating circuit that triggers an alarm upon detecting such temperature changes of the lack of motion from the safety personnel.

The Knapp et al. patent (U.S. Pat. No. 4,951,045) discloses a portable electronic warning device for warning pedestrians of temporary hazardous conditions, and includes three concentric lights surrounding a lighted message that illuminates upon detection of a pedestrian within predetermined detection range.

The Grasset patent (U.S. Pat. No. 5,337,046) discloses a communication system between vehicles and pedestrians, and includes transmitter/receiver devices carried by both pedestrians and vehicles with the vehicle transmitter/receiver detecting specific coded request signals from the pedestrian transmitter/receiver so that the vehicle can pick up the pedestrian.

The Sherburne et al. patent (U.S. Pat. No. 5,621,388) discloses a person locating system that includes a base station and a number of transceiver units that communicate with each other so that the base station can determine when the transceiver units are within the preselected distance and when any of the transceiver units are outside the preselected units.

The Greene patent (U.S. Pat. No. 5,905,432) discloses a vehicle anti-theft and anti-vandalism alarm that includes a processing device that receives signals from sensors and sends the coded signals to a transmitter and a second processing device for further decoding and visual display by the user so that the user can determine the status of the vehicle.

The Bryan patent (U.S. Pat. No. 6,044,698) discloses a system for monitoring anomalies in a railway station, and includes motion sensors mounted to the rail car chassis capable of signaling a GPS system when anomalies are detected so that a central monitoring station can be appraised of the event.

While the above systems and devices display notable ingenuity, there remains a need for a motion sensing system mountable to vehicles that immediately notifies the operator of the presence of pedestrians so that accidents, damage and injury to both the vehicle and the pedestrians can be avoided.

### SUMMARY OF THE INVENTION

The present invention comprehends a vehicle mounted pedestrian sensor system that can be retrofitted to vehicles such as construction equipment, garbage trucks, and commuter buses, or can be factory installed on the vehicle.

The vehicle sensor system includes at least five motion detectors or sensors mounted to the left side, the right side, the front, the back, and the underside or undercarriage of the vehicle. The motions detectors are electrically connected to an electrical control box that can be located adjacent the dashboard to the vehicle. In addition, an integral sensing switch is attached to either a wheel hub, the drive shaft or the transmission, and at least one brake pedal, for detecting when the vehicle comes to a stop so that the system can be activated for detecting passengers, children or pedestrians that come within a predetermined range of the motion detectors. The integral sensing switch is also electrically interconnected to the control box. Mounted by the dashboard or the gear shift box is a manually operable control panel that includes five position indicator lamps, one toggle switch, and three system mode indicator lamps, specifically, a test mode lamp, a standby lamp, and an automatic mode. The test mode is engaged to test the functioning of all the position indicator lamps, the standby mode is activated when the vehicle comes to a stop, and the automatic mode is toggled on to ready the system for use. Moreover, the vehicle detection system can be configured to detect the position of vehicles in relation to a railway crossing. In this embodiment, sensors can be mounted to the posts of railway crossing arms, and when a vehicle enters the sensing area, signals are sent to a transmitter box adjacent the railway crossing, and then the transmitter box generates further signals that are received by a receiver box in the train thereby alerting the train operator that a dangerous condition is present at the next rail crossing.

It is an objective of the present invention to provide a vehicle mounted pedestrian sensor system for protecting pedestrians, passengers, and children by automatically alerting the vehicle operator of their presence.

It is another objective of the present invention to provide a vehicle mounted pedestrian sensor system that automatically alerts the vehicle operator of the location (front, back, left side, right side, underside) of the pedestrian or child in relation to the vehicle.

It is still another objective of the present invention is to provide a vehicle mounted pedestrian sensor system that is adaptable for railway systems so that train operators can be alerted to the hazard and danger of vehicles or pedestrians that may be on or adjacent to the track intersection or crossing when the train is at least one mile from the potential hazard or danger.

Still yet another objective of the present invention is to provide a vehicle mounted pedestrian sensor system that is interconnected to the electrical and mechanical system of the vehicle.

A still further objective of the present invention is to provide a vehicle mounted pedestrian sensor system that operates in a standby mode when the vehicle is moving to prevent the generation of false warning signals.

A yet still further objective of the present invention is to provide a vehicle mounted pedestrian sensor that combines both visual and audible alert signals to alert the vehicle operator that an individual has been detected within the predetermined safety range.

These and other objects, features, and advantages will become apparent to one skilled in the art upon a perusal of the following detailed description read in conjunction with the following drawing figures.

### BRIEF DESCRIPTION OF THE DRAWINGS

FIG. 1 is a side elevational view of the vehicle mounted sensor system of the present invention illustrating the mounting of the motion detectors to the front, back and side of a commuter bus;

FIG. 2 is a side elevational view of the vehicle mounted sensor system of the present invention illustrating the mounting of a motion detector to the side opposite of that shown in FIG. 1;

FIG. 3 is a top plan view of the vehicle mounted sensor system of the present invention illustrating the mounting of the motion detectors to the commuter bus and a representative predetermined detection range of a side-mounted motion detector;

FIG. 4 is schematic view of one feature of the vehicle mounted sensor system of the present invention illustrating the interconnection of an integral sensing switch to the transmission and the brake pedal, and then to the control box;

FIG. 5 is a schematic view of an alternative embodiment of the feature first shown FIG. 4 wherein the interconnection of the integral sensing switch is to one of the wheel hubs and the brake pedal, and then to the control box;

FIG. 6 is a schematic view of an alternative embodiment of the feature first shown in FIG. 4 wherein the interconnection of the integral sensing switch is to the drive shaft and the brake pedal, and then to the control box;

FIG. 7 is a perspective view of the vehicle mounted sensor system of the present invention illustrating the layout of the control panel and arrangement of the indicator lamps, operational modes, and toggle switch;

FIG. 8 is an electrical schematic layout of the vehicle mounted sensor system of the present invention;

FIG. 9 is a perspective view of an alternative embodiment for the vehicle mounted sensor system for use in combination with a railway crossing and a train to alert the train operator of a dangerous condition at the railway crossing;

FIG. 10 is a top plan view of the alternative embodiment for the vehicle mounted sensor system illustrating the arrangement of the sensors in relation to the railway crossing and the approaching train; and

FIG. 11 is a perspective view of the alternative embodiment for the vehicle mounted sensor system illustrating the operator control box located within train cab for providing the train operator with data and alarm signals on the approaching dangerous condition at the railway crossing.

### DETAILED DESCRIPTION OF THE PREFERRED EMBODIMENT

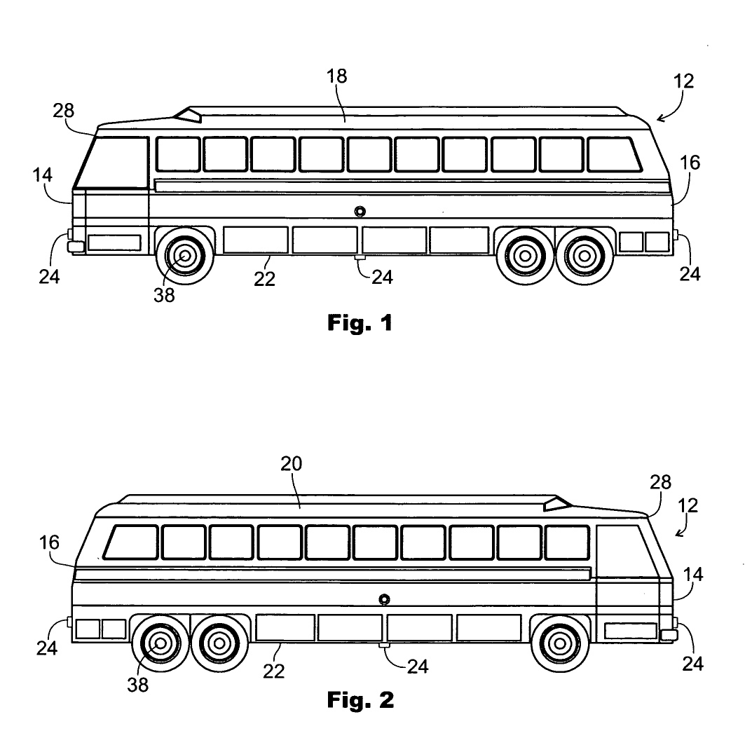

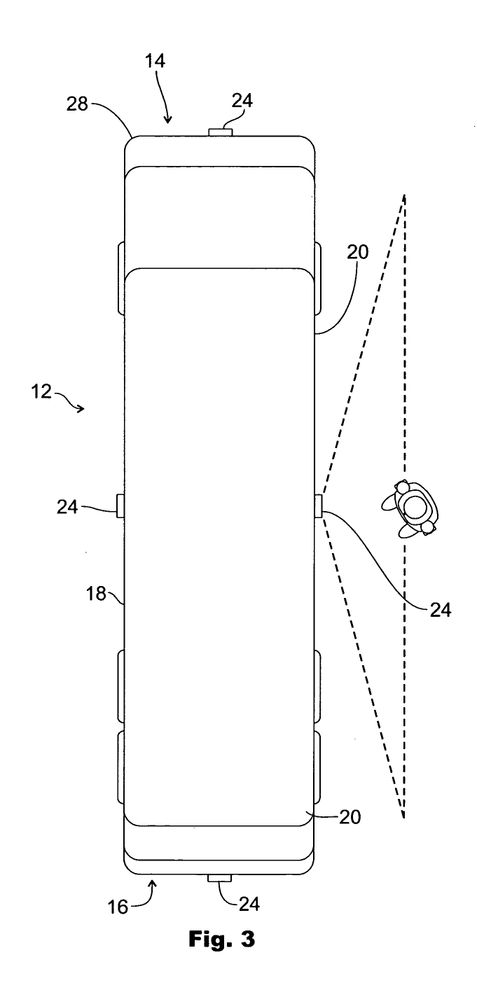

Illustrated in FIGS. 1-11 are several embodiments for a vehicle mounted sensor system for alerting the vehicle operator of the presence of pedestrians, passengers, and children of the fact that they are moving in front, in back or adjacent both sides of the vehicle and that a dangerous condition exists for all parties. The vehicle can be a commuter bus, construction equipment, moving vans, or garbage trucks; or any large vehicle that has obstructed sight lines or blind spots from the operator's vantage. Thus, the vehicle mounted sensor system is a protection system for both the vehicle operator and individuals moving about the perimeter or vicinity of the vehicle in so far as the individuals are protected from being injured by the vehicle sensor system, and the liability for the vehicle operator and owner is lessened by employing this safety system.

As shown in FIGS. 1-8, a preferred embodiment of the vehicle mounted sensor system 10 is mounted to and integrated with a representative vehicle that is a commuter bus 12 having a front side 14, a rear side 16, left 18 and right sides 20, and an undercarriage or underside 22. The sensor system 10 can be factory installed or retrofitted to the particular vehicle, and the sensor system 10 includes a number of features or elements that are integrated with, and interconnected to, the mechanical and electrical system of the vehicle such as the bus 12.

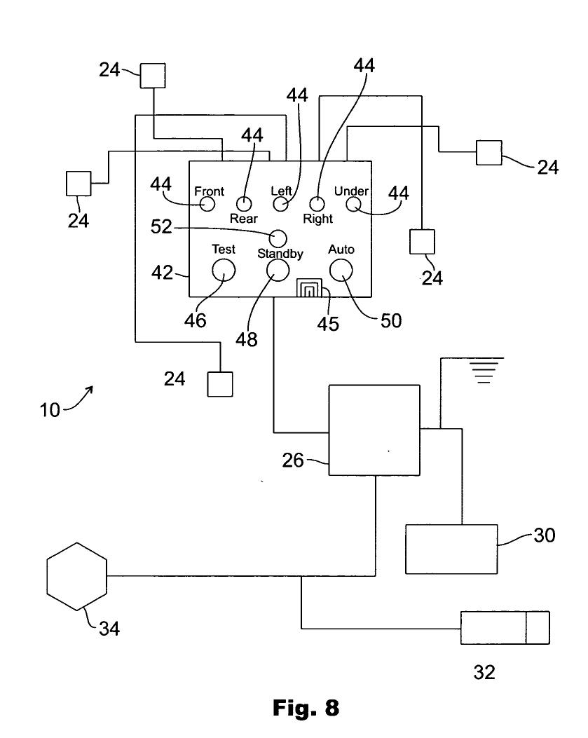

Thus, as shown in FIGS. 1-3, the vehicle sensor system 10 includes at least four motion detectors or sensors mounted 24 to the front side 14, the rear side 16, and the left and right sides 18 and 20 of the bus 12. If the vehicle undercarriage is greater than 12 inches from the road surface, a fifth motion detector or sensor 24 can be mounted to the undercarriage 22 as shown on the bus 12 of FIG. 3. This motion detector 24 would be for alerting the operator that small children have crawled underneath the bus 12. As shown in FIG. 8, a control box 26 is located within the cab 28 of the bus 12—perhaps underneath the dashboard—and includes standard computer logic circuitry for controlling the vehicle sensor system 10 as will be hereinafter further described. In addition, the control box 26 will also include circuitry for controlling other primary functions of the system 10 such as calibration of each motion sensor 24 for distance actuation, detection sensitivity level, and setting and adjusting the radius or range of detection. One suggested distance at which the motion detectors 24 can be calibrated for sensing objects and individuals is at a range of not less than two feet from the motion detectors 24 nor more than eight feet from the motion detectors 24 as shown in FIG. 3. A power source of any conventional type—electrical, battery, or solar—supplies power to the control box 26; or the control box 26 can be powered by the electrical system of the vehicle.

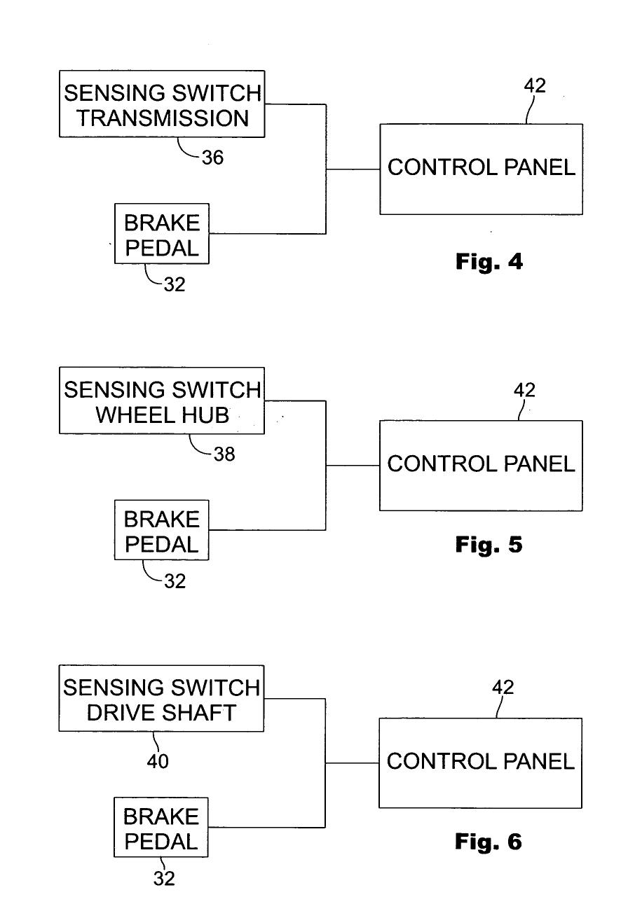

Furthermore, as shown in FIGS. 4-8, the vehicle sensor system 10 includes a means for determining the operational modes of the vehicle—that is, whether the vehicle is moving along a roadway, stopped, coming to a stop or starting to move. The means for determining the vehicle operational modes includes an integral sensing switch 30 that is attached to the foot brake 32 and electrically interconnected to the control box 26. In order to determine when the bus 12 has come to a stop or is starting to move, the integral sensing switch 30 must also be attached to, for example, a mechanical element 34 such as the transmission 36, at least one wheel hub 38, or the drive shaft 40 that directly participate in the vehicle's motion. FIGS. 4-6 further illustrate three possible ways of interconnecting the integral sensing switch 30 to the aforesaid mechanical elements 34 of the bus 12. The integral sensing switch 30 continuously communicates with the control box 26 for providing real time feedback on the operational mode of the bus 12 at each instant of the buses operation.

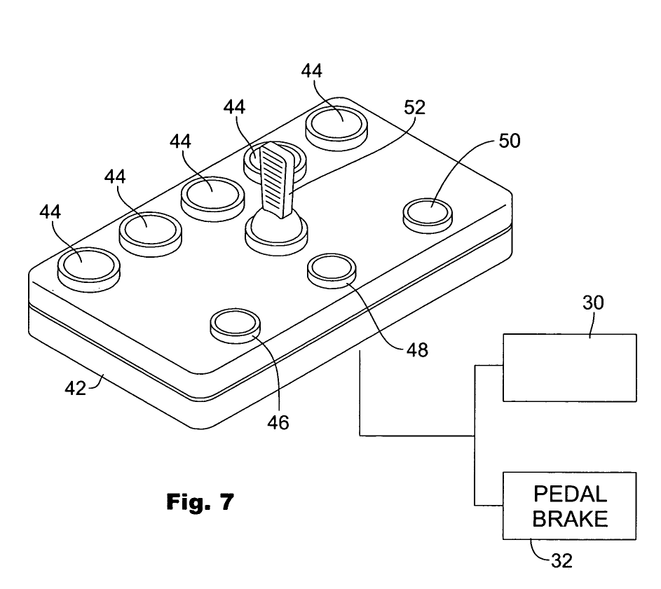

As shown in FIGS. 7 and 8, mounted adjacent to or on the bus dashboard is an operator alert and control panel 42 that is electrically connected to the control box 26. The operator's alert panel 42 includes visual alert means for alerting the operator that a pedestrian has come within the detection range of one or more of the sensors 24 and that a potential dangerous condition now exists. The operator alert and control panel 42 also includes operator calibration and control means for checking, calibrating and setting the various sensor system parameters and modes. More specifically, the sensor system 10 includes at least four—and in the embodiment of the present invention—five position indicator lamps or lights 44 that can be LED lights, each of which is associated with one particular motion detector 24 as shown in FIG. 8. As will be more fully explained, in order to alert the operator that one or more of the motion detectors 24 has detected a pedestrian, the associated indicator lamp or lamps 44 activate and turn red. It should also be noted that when one or more of the indicator lamps 44 turns red to indicate the detection of the presence of a pedestrian by the associated motion detector 24, an alarm or buzzer 45 will sound to further reinforce to the operator that a dangerous condition now exists about the vicinity of the bus 12.

The operator alert and control panel 42 also includes several operation mode lamps: specifically, a test mode lamp 46, a standby lamp 48, and auto, or on, lamp 50 each of each visually indicates to the operator certain information such as when the bus 12 is or is not on standby and whether the system 10 is working properly or whether there is a malfunction with one or more of the indicator lamps 44. A manually operable toggle switch 52 can be toggled among the three mode lamps 48, 50, and 52 to check, set and activate the system 10.

With reference to FIGS. 1-8 the operation of the vehicle mounted sensor system 10 will now be described. The first step is that the key should be turned on with the bus 12 set in park and running. The toggle switch 52 should be toggled to the test lamp 46 thereby placing the sensor system 10 in the test mode. The indicator lamps 44 will be illuminated green when functioning properly. The test mode lamp 46 illuminates green when toggled to the test mode; otherwise, the test mode lamp 46 illuminates red when inactive. The standby lamp 48 illuminates red when the vehicle sensor system 10 is not on standby (the bus 12 has come to a complete stop); and illuminates yellow when on standby (the bus 12 is moving). When the auto mode lamp 50 position is selected, the auto mode lamp 50 illuminates green, and illuminates red during system testing.

The operator should now exit the bus 12 and do a normal walk around inspection of the bus 12 passing by and triggering all the motion sensors 24. The motion sensor 24 mounted to the vehicle undercarriage 22 must be triggered by physically sweeping one's arm past that motion detector 24. After walking around the bus 12 and passing in front of and activating all the motion sensors 24, the operator should re-enter the bus 12 and examine the operator alert and control panel 42. If the indicator lamps 44 are illuminated red the sensor system 10 is functioning properly; if any indicator lamps 44 are illuminated green the walk-around inspection process should be repeated. If any indicator lamps 44 are still illuminated green, this may indicate several different problems: that the given motion sensor 24 may need recalibrated or the detection sensor sensitivity range may need adjusted. If the given motion sensor 24 is still illuminated green, the vehicle sensor system 10 may require technical evaluation and repair.

After the inspection has been completed, and it is determined that all the motion detectors 24 are properly functioning, the toggle switch 52 should be moved to the on or auto position—the auto lamp 50 position—and the system 10 will be in the standby mode indicating that the bus 12 is now in motion. The indicator lamps 44 will be illuminated green. When the system 10 is in the standby mode, the standby mode lamp 48 will be illuminated yellow and the auto mode lamp 50 will be illuminated green. The sensor system 10 is designed to automatically operate in the standby mode when the bus 12 is in motion. When the operator depresses the foot brake 32 bringing the bus 12 to a stop, the integral sensing switch 30 instantly detects that the bus 12 is stopping or stopped. As soon as the integral sensing switch 32 is activated, the system 10 goes to the automatic position and simultaneously illuminates the indicator lamps 44 green. Should a pedestrian, passenger, or child pass within the detection range of any motion detector 24, the indicator lamp 44 associated with that motion detector 24 will immediately turn red thereby indicating to the operator that someone has corn within the vicinity of the bus 12 and a dangerous condition now exists. The alarm or buzzer 45 on the control panel 42 will also sound thereby reinforcing the danger warning to the operator. When the dangerous condition has been verified and steps have been taken to correct the condition, the bus 12 can resume its movement. However, the automatic mode of the system 10 will operate on a five or ten second delay to alert the operator of a continuing dangerous situation should anyone move about or dart in front of the vehicle during this delay period. The standby mode lamp 48 will illuminate yellow to indicate that the system 10 is in the standby mode, and the process will be ready to repeat itself when the bus 12 comes to its next stop.

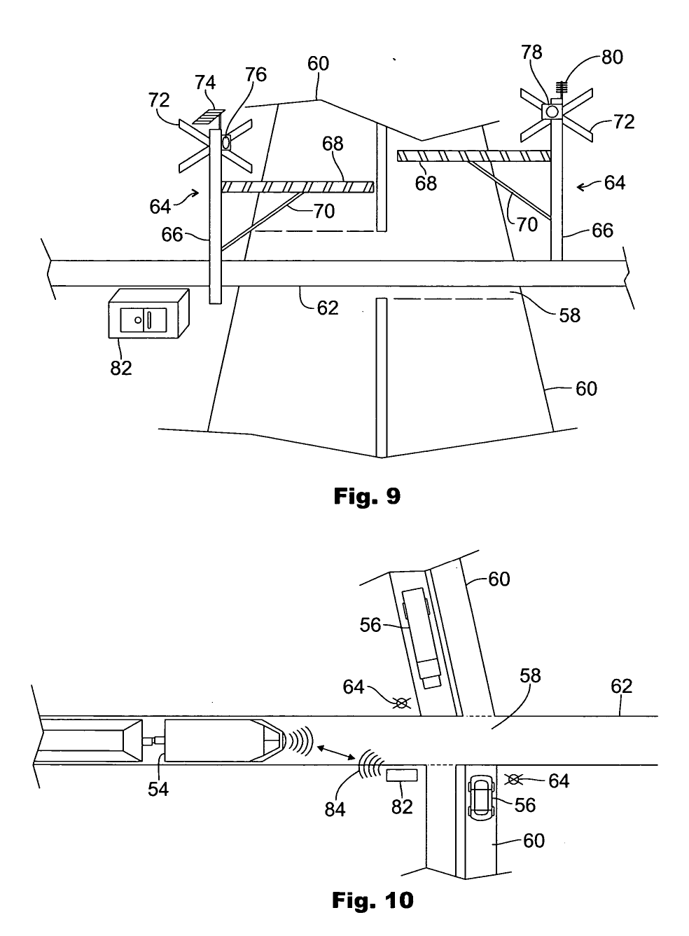

Illustrated in FIGS. 9-11 is an alternative embodiment for the vehicle mounted sensor system in which the sensor system is adapted for railway crossings to alert the operator of on oncoming train 54 that a vehicle, such as the vehicles 56 shown stopped before the railway crossing zone 58, has entered the railway crossing zone 58 and that the train 54 must be brought to a stop. Thus, a roadway 60 is intersected by a train track 62 at the railway-crossing zone 58. Located on opposite sides of the train track 62 are crossing guards 64 for signaling approaching vehicles to halt and not to enter the railway-crossing zone 58. The crossing guards 64 include support poles 66 to which are mounted pivotal crossing arms 68 and crossing arm support members 70 that pivot upward to block vehicles 56 from entering the railway crossing zone 58 and attempting to cross the train track 62. Adjacent the upper end of each support pole 66 are a pair of warning vanes 72 that oscillate for warning approaching vehicles 56 that the crossing arms 68 are down and that vehicular traffic should come to a stop before the railway crossing zone 58. Mounted atop one crossing guard 64 is a solar panel 74 and first sensor 76 while mounted atop the other crossing guard 64 is a second sensor 78 and an antenna 80 for sending and receiving signals. Located beside one crossing guard 64 is a power supply box 82 that provides power for the sensors 76 and 78 and includes conventional electronic circuitry to receive and interpret warning signals emanating from the sensors 76 and 78. The power supply box 82 also includes a transmitter device of conventional design for generating and transmitting signals of a specific channelized frequency 84 to the train 54 for alerting the train operator that the train 54 must be brought to a halt due to a dangerous situation that exists—: at least one vehicle 56 has passed between the crossing arms 68 and has been detected by the sensors 76 and 78 as being within the railway crossing zone 58. Also located inside the power supply box 82 is a storage battery for the solar panel 74. The batteries and the solar panel 74 provide back-up power for emergency situations.

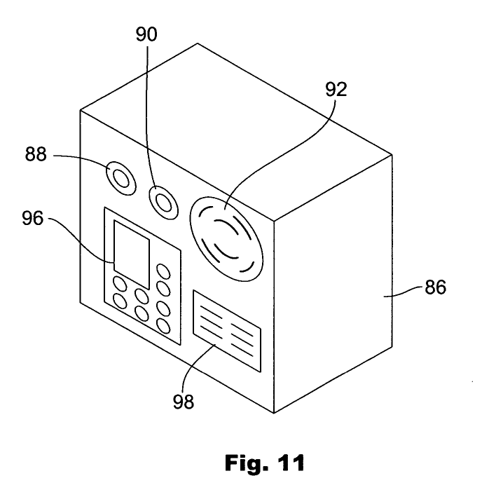

As shown in FIG. 11 the train 54 will include a train control box 86 that will be on as long as the train 54 is operating, and the train control box 86 will continuously monitor and pickup the signals sent from the power supply box 82. Preferably the warning signals generated from the train control box 86 should be received when the train 54 is up to one mile in advance of the railway-crossing zone 58. Also, the activation or trip system should preferably work off, and be integrated with, the crossing guards 64 and the crossing guard switches that are activated by the train 54 provided the crossing guard switches are located at a distance from the railway crossing zone 58 that gives the oncoming train 54 sufficient time to stop. The train control box 86 will include a safe indicator lamp 88 that will illuminate green for safe and a danger indicator lamp 90 that will illuminate red when the train control box 86 receives the appropriate signals from the power supply box 82 indicating that a dangerous condition exists within the railway crossing zone 58. An alarm speaker 92 will also be activated when the dangerous condition is identified as further augmentation of the dangerous situation along with the illumination of the danger indicator lamp 90.

Furthermore the train control box 86 can be preprogrammed with train route settings and crossing locations if the crossing guard switches are closer than one mile from the railway crossing zones 58 or the crossing guard switches are inefficient. The train control box 86 can be used for mapping out the railway crossings and are entered before the train 54 begins its trip, and the mapped out railway crossings can be visually identified on a read out screen 94 or manually produced for the operator on a printout pad 96.

While the invention has been illustrated and described in several preferred embodiments, it is not intended to be limited to the details shown, and it will be understood than numerous modifications, alterations, and variations can be made by those skilled in the art without departing in any way from the spirit of the present invention and the scope of the appended claims.

1. A sensor system mounted to a vehicle for detecting the presence of pedestrians when the pedestrians come within a pre-selected range of the vehicle, comprising:
a plurality of motion detectors with at least one motion detector mounted to the front, rear, left side and right side of the vehicle;
a control box mounted in the vehicle and electrically interconnected with the motion detectors for receiving signals therefrom;
an operator alert and control panel mounted within the vehicle cab and manually operable by the vehicle operator, the operator alert and control panel electrically interconnected to the control box and the motion detectors;
the operator alert and control panel including a plurality of indicator lamps with each indicator lamp associated with one specific motion detector and the indicator lamps capable of activation to illuminate in specific colors for indicating to the operator whether a pedestrian is beyond or has come within the range of the motion detectors and that a dangerous condition exists about the vicinity of the vehicle;
a test mode for indicating whether the system is functioning properly or requires servicing;
a standby lamp for indicating when the vehicle has come to a complete stop and when the vehicle is moving;
an auto mode lamp for indicating that the sensor system is ready for use in conjunction with the operation of the vehicle; and
an integral sensing switch attached to mechanical elements of the vehicle and for immediately communicating to the control box that the vehicle has been brought to a stop or that the vehicle is moving so that the motion detectors and the indicator lamps can be readied for activation should a pedestrian come within the pre-set range of the motion detectors.

2. The sensor system of claim 1 wherein the operator alert and control panel includes an alarm that sounds simultaneously with the illumination of the indicator lamps when the motion detectors have detected the presence of a pedestrian within the pre-set detection range.

3. The sensor system of claim 2 wherein the integral sensing switch is attachable to the transmission of the vehicle for immediately communicating to the control box that the vehicle has come to a stop and that the sensor system should go to the automatic mode thereby causing the indicator lamps to illuminate green.

4. The sensor system of claim 3 wherein the integral sensing switch is attachable to at least one wheel hub of the vehicle for immediately communicating to the control box that the vehicle has come to a stop and that the sensor system should go to the automatic mode thereby causing the indicator lamps to illuminate green.

5. The sensor system of claim 4 wherein the integral sensing switch is attachable to the drive shaft of the vehicle for immediately communicating to the control box that the vehicle has come to a stop and that the sensor system should go to the automatic mode thereby causing the indicator lamps to illuminate green.

6. The sensor system of claim 5 wherein the indicator lamps, when the vehicle has come to a stop and the sensor system is in the automatic mode, illuminate red when the motion detectors have detected the presence of a pedestrian within the pre-set detection range thereby alerting the operator that a dangerous condition exists in the vicinity of the vehicle.

7. The sensor system of claim 6 wherein the standby lamp illuminates red when the vehicle has been brought to a stop and illuminates yellow when the vehicle is in motion to indicate that the sensor system is in the standby mode.

8. A sensor system mounted to a vehicle for detecting the presence of pedestrians when the pedestrians come within a pre-set sensing range of the vehicle, comprising:
a plurality of motion detectors with at least one motion detector mounted to the front of the vehicle, one motion detector mounted to the rear of the vehicle, one motion detector mounted to the left side of the vehicle, and one motion detector mounted to the rear of the vehicle;
a control box mounted in the vehicle and electrically interconnected to the motion detectors for receiving signals from the motion detectors when the sensor system is in the automatic mode;
an operator alert and control panel mounted within the vehicle cab and manually operable by the vehicle operator, the operator alert and control panel electrically interconnected to the control box and the motion detectors;
the operator alert and control panel including a plurality of indicator lamps with each indicator lamp associated with one specific motion detector and the indicator lamps capable of actuation to illuminate in specific colors for indicating to the operator whether pedestrians are beyond the sensing range of the motion detectors or whether pedestrians have been detected within the sensing range of the motion detectors and that a dangerous condition exists about the vicinity of the vehicle;
a test mode lamp for indicating whether the sensor system is functioning properly or whether the sensor system requires servicing;
a standby lamp for indicating that the vehicle has come to a complete stop and when the vehicle is in motion;
an auto mode lamp for indicating that the sensor system is ready for use in conjunction with the operation of the vehicle; and
means for determining vehicle operation modes so that the sensor system can be in the standby mode when the vehicle is in motion and in the automatic mode with the sensor system activated when the vehicle comes to a stop.

9. The sensor system of claim 8 wherein the means for determining vehicle operation modes includes an integral sensing switch attached to mechanical elements of the vehicle for immediately communicating to the control box that the vehicle has been brought to a stop or that the vehicle is moving so that the motion detectors and the indicator lamps can be readied for operation should pedestrians come within the pre-set sensing range of the motion detectors.

10. The sensor system of claim 9 wherein the operator alert and control panel includes a buzzer that audibly sounds concomitant with the illumination of the indicator lamps when the motion detectors detect the presence of pedestrians that have come within the sensing range of the motion detectors.

11. The sensor system of claim 10 wherein the integral sensing switch is attachable to the transmission of the vehicle for immediately communicating to the control box that the vehicle has come to a stop and that the sensor system should go to the automatic mode thereby causing the indicator lamps to illuminate green.

12. The sensor system of claim 11 wherein the integral sensing switch is attachable to at least one wheel hub of the vehicle for immediately communicating to the control box that the vehicle has come to a stop and that the sensor system should go to the automatic mode thereby causing the indicator lamps to illuminate green.

13. The sensor system of claim 12 wherein the integral sensing switch is attachable to the drive shaft of the vehicle for immediately communicating to the control box that the vehicle has come to a stop and that the sensor system should go to the automatic mode thereby causing the indicator lamps to illuminate green.

14. The sensor system of claim 13 wherein the indicator lamps, when the vehicle has come to a stop and the sensor system is in the automatic mode, illuminate red when the motion detectors sense the presence of pedestrians within the pre-set sensing range of the motion detectors thereby alerting the operator that a dangerous condition exists with the vicinity of the vehicle.

15. The sensor system of claim 14 wherein the standby lamps illuminates red when the vehicle has been brought to a stop and illuminates yellow when the vehicle is in motion to indicate that the sensor system is in the standby mode.

16. A sensor system for signaling to an approaching train that a vehicle has passed the crossing guards and has entered the railway crossing zone through which the train track runs, comprising:
a first vehicle sensor mounted atop of one crossing guard and a second vehicle sensor mounted atop the other crossing guard, the sensors capable of sensing any vehicle that has passed beyond the crossing guards and has entered the railway crossing zone;
a power supply box located adjacent one crossing guard for receiving the signals from the sensors and for generating and transmitting signals of a specific frequency to approaching train;
a train control sensor box located within the train for receiving the transmitted signals from the power supply box indicating to the train operator that a vehicle has entered the railway-crossing zone;
a safe indicator lamp located on the train control sensor box for illuminating and signaling to the train operator that no vehicle has entered the railway-crossing zone;
a danger indicator lamp located on the train control sensor box for illuminating and signaling to the train operator that a dangerous condition exists at the railway crossing zone and that the train must be brought to a halt before reaching the railway crossing zone; and
an alarm speaker located on the train control sensor box for producing an audible warning sound concomitant with the illumination of the danger indicator lamp thus alerting the train operator that the train must be brought to a halt before reaching the railway crossing zone.

17. The sensor system for signaling an approaching train of claim 16 wherein the train control sensor box can be preprogrammed with train routes and railway crossing locations before the train commences its trip.

18. The sensor system for signaling an approaching train of claim 17 further comprising a printout pad located on the train control sensor box for mapping and printing out the railway crossings along the route.

19. The sensor system for signaling an approaching train of claim 18 further comprising a read-out screen for visually displaying the mapped-out locations of the railway crossings along the route.
